(19) United States
(12) Patent Application Publication
(10) Pub. No.: US 2018/0005310 A1
(43) Pub. Date: Jan. 4, 2018

(54) METHOD FOR SHARING LABORATORY SURPLUS IMPLEMENTED BY COMPUTER

(71) Applicant: Alcino Orféu de LEÃO E FLORES, Charneca da Caparica (PT)

(72) Inventor: Alcino Orféu de LEÃO E FLORES, Charneca da Caparica (PT)

(21) Appl. No.: 15/196,303

(22) Filed: Jun. 29, 2016

(51) Int. Cl. G06Q 30/06; G06Q 40/04; G06Q 10/08

(52) U.S. Cl. CPC G06Q 30/0641; G06Q 10/087; G06Q 40/04

(57) ABSTRACT

A method for sharing of equipment surplus, consumables leftovers and other goods or services originated in research laboratories, clinical research laboratories or any other laboratories, research facilities or academic agencies between users, shared with other similar laboratories or academic agencies, intermediated and managed in an online platform where both the offer and the need are published.

### FIELD OF THE INVENTION

The present invention is in the technical field of sharing economy. More particularly, the present invention is in the technical field of equipment surplus sharing, consumables leftovers and other goods or services originated in research laboratories, clinical research laboratories or any other laboratories, research facilities or academic agencies that are to be shared with other similar laboratories or academic agencies.

### BACKGROUND OF THE INVENTION

In laboratory and university related institutions, for example research centers, as well as companies, it is very common to find unused equipments, machines and equipments not fully booked, reagent leftovers and other goods still adequate for further using, provided the expiry date has not been reached in case of perishable goods such as e.g. reagents.

Services provided by these parties, such as consultancy services, technical support, software development or use, and maintenance or others are also elected goods to be exchanged or shared on a network resulting from the present invention.

Laboratory Head-Officers and other people, responsible for managing the inventory of laboratories are commonly deprived of commercial autonomy, e.g., not authorized to issue invoices in the name of the University, academic centre or organization for which they work or to buy new items in the name of such entities, without having to go through a laborious and time consuming procedure.

Furthermore, they frequently buy such equipments and/or reagents with their own money or with income originating from public or private funds for their scientific projects and the present invention provides them with a particularly effective way to gain both physical space—getting rid of unused bulky items—and also acquiring other goods (new or leftover products, apparatus or services) they can actually use on their current projects and activities, without having to spend money, provided all the requirements according to the local legal system regarding taxes are complied with.

There are many websites and electronic commerce (also known as e-commerce) marketplaces where a scientist working for a University or any other type of research laboratory can buy consumables or equipment needed for his/her research. However, the available e-commerce marketplaces are mostly business-to-business (B2B) or business-to-consumer (B2C).

There is no consumer-to-consumer (C2C) marketplace that is specific for facilitating sharing of equipment surplus or consumable leftovers between researchers working in different laboratories. This is also valid for sharing other goods and services that laboratories can provide to each other.

### SUMMARY OF THE INVENTION

The present invention enables academic, clinical or research facilities and laboratories to share goods and services that one laboratory needs and another laboratory considers a surplus or leftover. Sharing is intermediated and managed in an online platform where both the offer and the need are published on a website, regardless of the place from where the user is publishing.

The online platform is also a networking place for scientists, research and clinical research related staff, experts in specific fields of biology such as bird breeders, insect breeders, fish breeders and plant breeders, and other professionals working in science and/or technological innovation fields, that combined may form a community of common scientific interest and/or background. The goods and services shared in the online platform of the invention have a fixed virtual value or rating given by the offering user. The user searching for the item may negotiate and decide the terms of the sharing and delivering with the offering user.

The online platform is also an alternative over the grant system for supplying the resources needed to produce science, since monetary units can be cashed-out through the platform to acquire the same goods or services that those grants can buy.

### BRIEF DESCRIPTION OF DRAWINGS

FIG. 1 is a diagram of the steps composing the method of invention when posting an offer.

FIG. 2 is a diagram of the steps composing the method of invention when posting a need.

### DETAILED DESCRIPTION OF THE INVENTION

The method according to the present invention is implemented by an online platform, preferably cloud-based, enhancing significantly the availability and effectiveness of the resulting networking online platform, to all users and parties involved.

Other server-type based solutions, although less effective and available, are also provided by the present invention.

Users have to register in the network and provide minimum details such as name, institution to which they are affiliated, physical address, electronic address and telephone number.

Sharing and exchange of goods and services are only possible via the online platform to registered users.

All items shared or exchanged in the network of the present invention are marked with an exchange value based on a fictional monetary unit.

The fictional monetary unit is issued and managed exclusively in the online platform of the present invention.

Sharing and exchanging goods and services in the network of the invention is only possible by using the fictional unit.

Real money or other regular payment mode is used only for getting access to the fictional monetary exchange units, which are issued and sold exclusively by the Administrator of the online platform.

Fictional monetary exchange units, are to be mandatorily used within the provided network.

Within the meaning of the invention an ‘item’ refers to any product, equipment, software, bioinformatics services, bioinformatics science, bioinformatics analysis and/or any other service that a laboratory may have in excess or as part of the user's expertise, and is willing to share or exchange for something in the future.

The online platform of the invention provides a mean for any registered user to offer, buy and announce a need and exchange the monetary units for goods or services of common use in research laboratories, which usually are acquired via grants.

An item within the meaning of the invention is, in an exemplary non limiting manner, a reagent, chemical substance, biological sample, living organism, biological specimen, equipment, test, etc.

A surplus within the meaning of the invention is an item existing in excess. As a non-limiting example, an item in excess may be a certain amount of a chemical reagent, still in appropriate condition or shape to be used, not fully consumed but not needed anymore, or equipment not fully booked for use. An offer is the act of transacting an item in excess.

A shortage of an item within the meaning of the invention is the same as a need. In a non-limiting example, a shortage is a missing reagent, sample or equipment

The monetary units used in the online platform are a way of storing the potential value of an item that cannot be sold under real monetary conditions (i.e, in exchange for money). They can also be used for cashing out and acquire any scientific resource, to be provided with the intermediation of the administrator.

Said in a different manner, the invention enables the acquisition of items without the use of money, by direct exchange or sharing of items between users.

The exchange value is established by the user offering the item and should be negotiated by the user interested in acquiring the item.

The administrator has no involvement in rating items. Rating items means defining that a certain item corresponds to a certain number of monetary units.

Rating an item is entirely a subjective appreciation of the user who is making the offer.

It is expected that in time, as a history of sharing and exchanging items in the community is reached, a reasonable rating for the same type of items is attained.

The landing page of the online platform is divided into three areas: a header, an area displaying the most recent publications—offers or needs—and an area containing the user's most recent activity.

The heading contains only few options to ease navigation in the online platform. The options are marketplace (or similar), publish (or similar), chat (or similar) and negotiate (or similar) and history (or similar).

When a given user wants to acquire a certain item (product, equipment or service), he/she performs a search in the search field of the online platform.

The user may also consult the available information on the landing screen regarding the most recently made available items.

Each post published with the “publish” option, advertising new items available, contains information about the type of item —product, service, left over, equipment surplus or equipment time—description, keywords and images if appropriate.

There is also information about the user and the amount of fictional exchange coins it amounts. The field for description of the item should contain information about the general condition, amount or volume and shelf-life when applicable, reason for selling or bartering, location, and any other useful information.

As for the provider, the available information may refer to the reliability of such provider, predicted time and mode for delivery of such item with a summarized history, such as a log status, of previous transactions where this provider was part in.

When the user with the need finds an appropriate item and wants to proceed with the transaction he/she will simply transfer the correct amount of fictional monetary units to the provider by clicking a “order-like” or other functionally similar button.

When confirming the transaction, the user with the need sees the monetary units immediately spent. However, the user providing the item sees the monetary units in a “provisional state”. Only when the item is delivered are the monetary units effectively transferred and the transaction completed.

The user acquiring the item may follow the order status and fictional monetary exchange units available in the online platform.

If the user acquiring the item does not have enough monetary units to complete the transaction he/she may gain access to them directly from the managing entity by clicking the “Acquire coins” or other functionally similar button. Acquisition of monetary units is subject to the permanently fixed conversion ratio which is a fixed rate for monetary units provided by the administrator.

In this particular case, when the administrator is offering an item in response of a published user need, the administrator is seen as a general user offering an item and for that matter, the same steps for general users offering items apply.

Each item shared or exchanged via the online platform of the present invention is evaluated with a certain amount of monetary units by the user providing the item.

However, the Administrator of the online platform may validate the evaluation before rendering the item available for sharing or exchanging within the network.

The provider may also follow the order status and fictional monetary exchange units availability within the provided online platform.

All users and entities may assess the performance and quality of providers within the network and the resulting rank is available for all users.

A typical transaction can be described as follows: a first user (user A) wanting to acquire a certain item searches for keywords or other applicable search method within the online platform of the invention.

If such item is available within the user network, user A may acquire it if he/she has enough monetary units. User A may proceed with the transaction directly with the provider (user B) or through managing entity or Administrator.

If the desired product is not being offered by any user of the online platform, user A may require the Administrator to acquire the item directly to the external provider (not part of the network) and the Administrator will render the item available within the provided network and send a written notice, preferably electronic, to user A.

Invoices regarding all transactions involving the ordering of monetary units are exclusively issued and converted into real currency by the managing entity, the Administrator, according to the provided conversion rate on conditions of use.

The general steps of the method of the invention, either for offers or needs is as follows:
publishing an offer or need of an item;
rating an item;
negotiating an item;
agreeing on terms;
exchanging monetary units for the item; and
finalizing the transaction.

The following are illustrative examples of how the invention may be used, but they are by no means a limitation of the application of the invention:

### Example 1

A DNA research laboratory in Canada needs three portions of a reagent to conduct one particular essay. The reagent is sold commercially in batches of 50 portions, each portion with an expiry date of 3 months after production. The head of the research lab does not have additional essays scheduled for the next 6 months. Should he buy the batch of 50 portions from the commercial manufacturer he would end up throwing out the remaining 47 portions of the reagent. Instead of buying the reagent he posts a ‘need’ on the website and gets in touch with a research lab in Japan who has bought one batch of 50 portions to the commercial manufacturer 2 months earlier but only used portions, having a 10 portions surplus available. After negotiating they agree on the value exchange and the delivery address. The user who posted the need sends the monetary units to the user who has the reagent surplus. The user who has the reagent surplus dispatches the agreed reagent to the user who needs them. On confirmation of receipt by the user in the Canadian laboratory the monetary units are confirmed on the Japanese user account.

### Example 2

A university research centre in Brazil has recently acquired a gel electrophoresis apparatus. During student's summer holidays the equipment will not be used. The head of department posts an advertisement of an equipment available for use. A user in the United States needs some tests done with a gel electrophoresis equipment but does not want to buy one because he doesn't use it on a day to day basis. The users get in touch and after negotiating and agreeing on the rate, they decide the details of the share such as the time the apparatus will be used, the terms of use and who will conduct the test. The research centre in Brazil has qualified staff available to work on the test. The alternative would be someone from the United States to perform the test at the university research centre in Brazil. The monetary units are processed as described in Example 1.

### Example 3

One Professor in Ukraine wants to attend a conference in France. The Ukrainian University has maxed out their budget for travelling to conferences for the present semester. The Professor has enough monetary units to cover the costs of attending the conference at the permanently fixed conversion ratio. The Professor uses the online platform to cash out his monetary units. The administrator acquires the tickets for the conference on behalf of the Professor, and sends him all the necessary documentation for travelling to France and for attending the conference. The administrator subtracts the corresponding monetary units from the personal account, on the online platform of the invention, of the Ukrainian Professor.

The negotiation phase of the method of the invention involves the use of a messaging feature embedded in the website. Similar in design to any instant messaging software, the messaging feature allows users to communicate in private and discuss the terms of the sharing, exchanging, rating and delivering until they reach an agreement.

Users can use the messaging feature only when they have their allow access to their profiles.

While the foregoing written description of the invention enables one of ordinary skill to make and use what is considered presently to be the best mode thereof, those of ordinary skill will understand and appreciate the existence of variations, combinations and equivalents of the specific embodiment, method and examples herein.

This invention should therefore not be limited by the above described embodiment, method, and examples, but by all embodiments and methods within the scope and spirit of the invention as claimed.

### DETAILED DESCRIPTION OF DRAWINGS

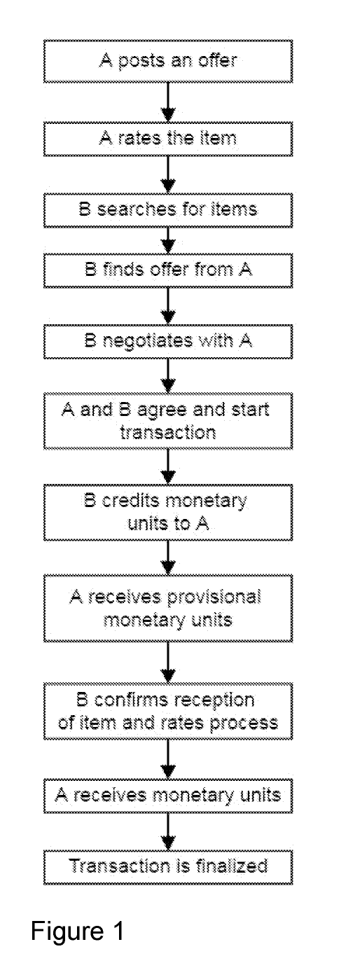

FIG. 1 shows the steps of the method of the invention, when a user has a surplus of an item and therefore wishes to make an offer:
1—User A publishes and offer for an item;
2—User A rates the item;
3—User B searches for items;
4—User B finds User A offer;
5—User B negotiates rating, terms and delivery;
6—User A and User B find an agreement and start the transaction;
7—User B credits monetary units to user A account at the online platform of the invention;
8—User A receives provisional monetary units;
User B confirms receipt of the item and rates the process;
10—User A receives monetary units;
11—The transaction is finalized.

Within the meaning of the invention, “rating the process” means that the user evaluates how successful the transaction was, by assigning a score in a scale, e.g. one to five stars wherein one in very unsuccessful and five is very successful, and providing written feedback on the interaction with the other user.

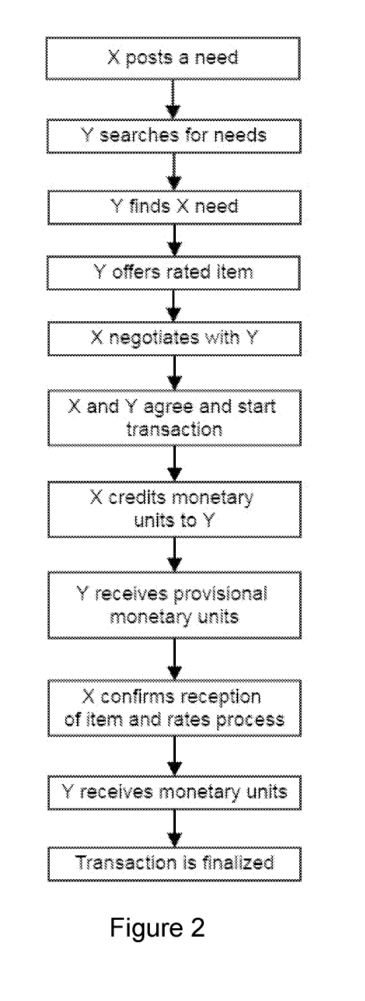

FIG. 2 shows the steps of the method of the invention, when a user is in need of item and therefore wishes to post a need:
1—User X publishes a need for an item;
2—User Y searches for needs;
3—User Y finds User X need;
4—User Y offers the item at a certain rate;
5—User X negotiates rating, terms and delivery;
6—User X and User Y find an agreement and start the transaction;
7—User X credits monetary units to user Y account at the online platform of the invention;
8—User Y receives provisional monetary units;
9—User X confirms receipt of the item and rates the process;
10—User Y receives monetary units;
11—The transaction is finalized.

1. A method for sharing items between users, the method comprising the computer-implemented steps of:
(a) publishing an offer or need of an item;
(b) rating the item;
(c) negotiating the item;
(d) agreeing on terms;
(e) exchanging monetary units for the item; and
(f) finalizing the transaction.

2. The method as recited in claim 1 wherein the item is selected from the group consisting of: a product, a software, an equipment and a service; in excess or part of the user's expertise.

3. The method as recited in claim 1 wherein the item is selected from the group consisting of: a reagent, a chemical substance, a biological sample, an equipment and a test.

4. A method for sharing items between users, when making an offer for an item in excess, the method comprising the computer-implemented steps of:
(1) a first user publishes an offer for an item;
(2) the first user rates the item;
(3) a second user searches for items;
(4) the second user finds the offer from the first user;
(5) the second user negotiates rating, terms and delivery;
(6) the first and second users agree and start the transaction;
(7) the second user credits monetary units to a first user's account at the online platform of the invention;
(8) the first user receives provisional monetary units;
(9) the second user confirms receipt of the item and rates the process;
(10) the first user receives monetary units; and
(11) the transaction is finalized.

5. A method for sharing items between users, when having a shortage for an item, the method comprising the computer-implemented steps of:
(1) a first user publishes a need for an item;
(2) a second user searches for needs;
(3) the second user finds the first user's need;
(4) the second user offers the item at a certain rate;
(5) the first user negotiates rating, terms and delivery;
(6) the first and second users agree and start the transaction;
(7) the first user credits monetary units into a second user's account at the online platform of the invention;
(8) the second user receives provisional monetary units;
(9) the first user confirms receipt of the item and rates the process;
(10) the second user receives monetary units; and
(11) the transaction is finalized.

6. The method as recited in claim 1, wherein the second user is an administrator of the online platform.

7. The method as recited in claim 4, wherein the second user is an administrator of the online platform.

8. The method as recited in claim 5, wherein the second user is an administrator of the online platform.
